(19) United States
(12) Patent Application Publication
(10) Pub. No.: US 2016/0124206 A1
(43) Pub. Date: May 5, 2016

(54) POC-TEST SYSTEM WITH MOBILE COMPUTER UNIT AND METHOD

(71) Applicant: ZENDIA GMBH, Sendenhorst-Albersloh (DE)

(72) Inventors: Guido BÖSE, Sendenhorst-Albersloh (DE); Björn LINDEMANN, Hamburg (DE)

(21) Appl. No.: 14/654,657

(22) PCT Filed: Dec. 23, 2013
(86) PCT No.: PCT/EP2013/077965

§ 371 Date: Oct. 16, 2015

(30) Foreign Application Priority Data
Dec. 22, 2012 (EP) 12199312.5

(51) Int. Cl. G02B 21/36; G02B 21/02; G02B 21/26; G02B 21/06

(52) U.S. Cl. CPC G02B 21/362; G02B 21/365; G02B 21/06; G02B 21/02; G02B 21/26

(57) ABSTRACT

This invention relates to a test system along with test strips and a test process and its use, especially in the point of care (PoC) area, the test system comprising a mobile computing device having an image processing device arranged on an optical magnification device that is used to analyze body fluids.

This invention relates to a test system along with test strips and a test process and its use, especially in the point of care (PoC) area, the test system comprising a mobile computing device having an image processing device arranged on an optical magnification device that is used to analyze body fluids.

In research, diagnosis, or many other fields of application, analytical laboratory tests for qualitative and/or quantitative determination of cells, molecules, ligands, analytes, or their activity or composition, form the basis for far-reaching statements all the way to the development of new processes or devices. They are based on generally known methods of DNA/RNA analysis or protein analysis. Another example is provided by the many analytical processes and methods that are used to [detect] antibody reactions, so-called immune reactions, which are used for the determination of (bio)markers and many other substances/analytes. Furthermore, microscope-based processes are described in the area of diagnosis.

Patient-oriented or “point of care” (PoC) test processes are diagnostic tests that can be carried out within a short time on-site, directly on the individual patient/subject, rather than in a central laboratory.

For a few parameters there are PoC test systems such as immunochromatographic test strips that detect, through antibody binding, a soluble biomolecule, e.g., a hormone or a protein in blood, urine, or saliva, using a color reaction.

Known PoC test strips are, for example, pregnancy tests or blood coagulation tests, which are offered with or without a measuring instrument. Also known are associated rapid test processes, such as the lateral flow test (LFT), flow-through test (FTT), agglutination test (AT), or solid-phase test (SPT). All these processes are used for rapid detection of analytes and are suitable for visual evaluation in the PoC area.

The PoC area requires robust and rapid diagnosis meeting the special needs, e.g., of emergency medicine, and requiring high mobility and/or connectivity to medical treatment specialists.

However, there are no PoC tests for a large number of diseases, some of which are life-threatening, which are the object of pathogen or cell diagnosis. These diseases include severe bacterial infections that can lead to sepsis, diseases such as malaria, cholera, and tuberculosis; and there are also no tests for quantifying certain blood cells, e.g., lymphocytes, in cancer patients. Pathogen and cell tests still require an apparatus- and labor-intensive test in the diagnostic laboratory, which is, accordingly, costly and time-consuming, and additionally delays the beginning of individual treatment or therapy.

A required pathogen and cell diagnosis is explained using malaria as an example:

In 2010, 216 million cases of malaria were reported from 106 countries. According to information of the WHO, in 2010 the number of persons that died from malaria throughout the world was 655,000, most of them children under the age of three years. More than 90% of cases of this disease throughout the world are caused by the endoparasite Plasmodium falciparum; in most cases, if the disease is untreated or inadequately treated it has a lethal outcome.

The standard prior art method of diagnosing malaria is based on microscopy. A small amount of blood is collected, of which a smear or a preparation in the form of a so-called thick drop is prepared and stained with Giemsa stain. After the preparation is fixed and dried, the person skilled in the art can identify the parasite in the red blood cells (erythrocytes) and differentiate it under the microscope.

This method presumes not only a trained microscopist, but also a laboratory environment and an expensive microscope. In most malarial regions no laboratory equipped in this way is available anyway.

In addition, existing molecular biology tests are expensive and also require in-depth knowledge on the part of the person using them.

Also known are lateral flow rapid tests (see above), which although they can detect parasite-specific antigens, cannot detect the parasites as such or infected cells, and therefore do not allow pathogen or cell diagnosis.

Therefore, systems that have a powerful mobile computing device (e.g., a smartphone), such as described in the prior art, e.g., in DE202010007208U1, are of special interest. Such test systems are used to determine blood sugar, for example, a test strip with patient blood being measured, e.g., by electrochemical means, and simple analyses being carried out. However, suitable pathogen and cell diagnosis has not been described for test systems that have a mobile computing device.

However, there is great need for a test system with a mobile computing device that allows complex diagnosis.

In particular, this complex diagnosis should allow pathogen and cell diagnosis from body fluids.

Therefore, it is the goal of this invention to make available a test system that allows effective pathogen and cell diagnosis from body fluids in the PoC area.

The goal of this invention is achieved as follows:

A test system is made available comprising
i.) a mobile computing device;
ii.) an image processing device arranged on at least one optical magnification device; and
iii.) means to mount and remove a test strip having a body fluid of a (patient/subject) sample.

The invention also provides that the test strip be arranged in such a way that the image processing device along with at least one optical magnification device allows optical read-out of the body fluid.

A preferred embodiment has the optical magnification device oriented toward or arranged on the test strip, so that an image or picture or series of pictures or moving picture (also called a video), preferably at least one contrast picture is taken in the presence of the test strip, and the picture that is obtained is captured by the image processing device and read out by the mobile computing device.

It is further preferred for the planar test strip with a first surface of the optical magnification device containing at least one objective to be arranged perpendicular to the objective axis of at least one objective.

In the context of this invention, “mobile computing device” means a device that has computing capability such as that provided, for example, by a mobile telephone (commercially available as a “smartphone”, for example) or by a laptop or tablet computer (frequently commercially available as a “tablet”), which especially preferably already contain an integrated image processing device (“iPod®, iPhone®, Android®, iPad®, Windows® Phone”, and many others).

The mobile computing device has essentially one central unit called the processor that can perform all the computing and process steps required for image processing.

An image processing device should also be inventively arranged with respect to the mobile computing device, in particular in the form of a camera. The image processing device can be used to capture image data from an optical magnification device. This can be done by photographing the image produced by the optical magnification device. Especially if the optical magnification device's optics are optimized for a camera, this is a very expedient way [of providing this capability]. Digital cameras are preferred, that is those with an image sensor whose data is output to a digital storage medium. The image sensor can a common CCD sensor. A CMOS sensor can also be used, however it is not required. It is expedient for filters to be placed in front of the sensor, for example, an infrared, low-pass, and/or color filter.

The digital storage medium can be associated with the image processing device, that is, physically placed adjacent to the optics and/or only store the image data captured by the image processing device. Therefore, it is also possible for an image processing device to be placed in a separate housing and supply data to the mobile computing device through a wireless or cable connection. However, according to the invention an integrated solution is preferred in which it is possible to use a storage medium that also serves other applications. This can be the case, for example, in a smartphone, where storage space is provided for many purposes.

The image processing device can be operated in a recording mode for individual pictures, series of pictures, or moving pictures (also called video). Taking a series of pictures involves taking several pictures at one resolution at a fixed time interval, for example five pictures at a time interval of one second. Such a series of pictures makes it easy to see changes in the object pictured. If it can be assumed that the object does not change, comparison of the different pictures can be used to increase the image quality.

In the context of this invention, image processing is always provided. To accomplish this, a storage medium for image data and a processor must be available. If used as mobile computing devices, current smartphones are equipped with sufficient processors, for example, frequently already with four processor cores (quad-core), which is desirable, but not required. It is desirable for the processor to have a clock rate of more than 0.5 GHz. This is also achieved by current smartphones or tablet computers (see above).

Inventive processing of image data requires an image processing program. It is possible, but usually unnecessary, to write dedicated programs to carry out all the operations to be performed. Therefore, it is possible to use image processing software with extensive capabilities that can be adapted to the requirements of the invention, for example by freely programmable routines. In particular, smartphones offer operating systems that allow the programming and use of small programs optimized for a specific purpose (“apps”). In such operating systems it is possible to create the program's basic functions (for instance data manipulation) with very little programming effort. Therefore, such apps are especially suitable to assume the image processing in the context of this invention.

The image processing should possibly be designed for an analysis mode. According to the invention, the point is not to represent individual structures of a picture accurately and sharply and/or to analyze them, but rather to capture total color values or color contrasts, preferably of fluorescent colors, in part of a picture. This capture can be qualitative, however as a rule it is also quantitative. For example, a simple quantitative evaluation can involve stating whether stained areas exceed a specified critical value. It is preferable for the image to be evaluated as an integration, by calculating the sum or integral of certain color values or color contrasts relative to all other values in part of a picture. It is expedient for the particular color values or color contrasts to be a narrow interval of color values, however in an individual case it can also be a single color value. Such color values can be defined on a usual color scale, for example an RAL scale, or the process [can] allow color contrasts or relative color contrasts to be determined, possibly in the form of a ratio of one or more color values. Therefore, in the context of this invention, color values and color contrasts are discussed as synonyms in the broadest sense.

The quality of image processing can be increased by examining individual parts of a picture of a larger field one after the other. This can be done by pure selection in image processing. This can also alternatively or additionally be done by optical magnification of each part of a picture (“zooming”). This can also alternatively or additionally be done by mechanically moving the sample relative to the inventive optics, as described above (see “dynamic method” below). Flowing or transport of the sample or test strip relative to the inventive optics is especially preferred. This advantageously allows complete capture of an inventive sample for image processing.

The image processing can advantageously be done immediately during this transport, or during the transport series of pictures (also: videos) can be taken, which are evaluated later.

Image evaluation can also include quality analysis. This can involve calculating the standard deviation of the results in several parts of a picture. Alternatively or additionally, it can also involve determining how close a calculated value is to a critical value. If it is very close or if the standard deviation is large, this points to poor quality of the measurement. Moreover, a new test can also be requested.

Consequently, to use this invention it is helpful to have a program on a computing device, for example in the form of an app on a smartphone, that combines the following basic functions: Reading in of image data, image processing, and quantitative and/or qualitative output of an image processing and/or analysis result. In addition, the program can offer quality analysis of the quality of the analysis of a sample. It is also possible to provide linkage with other information (internal or external databases on clinical pictures, addresses of medical services, and similar things). Linkage with such information can be made dependent on the analysis result.

The inventive mobile computing device preferably has at least one data connection, preferably also in the form of an Internet connection. This connection can also be used to store all or some data outside the mobile computing device (the data need not be stored on a dedicated computer, but can be stored in external server-based storage, e.g., in a “Cloud”). Computer operations can be carried out by other computers (here again, the computing power can be made available over a suitable network, and thus not be provided by a selected, permanently dedicated computer). The data connection, in particular the Internet connection, can be cable-based or wireless, e.g., it can take place over a network based on the W-LAN protocol or over a data network based on the UMTS or LTE standard.

The mobile computing device should also have input capability, for example a keyboard or a touch screen. For data output, a small screen is frequently sufficient (for instance, with a diagonal between five and ten inches). This screen can also indicate whether the captured image data is good enough, so that a new picture can be taken immediately, if necessary.

Therefore, according to the invention it is preferred for the mobile computing device to be a smartphone or tablet computer, and for the image processing device to be a digital camera, which preferably is integrated in a smartphone or tablet computer or is located in a separate device connected with the smartphone or tablet computer.

In the context of this invention, “optical magnification device” means a device that contains at least one objective or an arrangement of one or more objectives or lenses, as is the case in a microscope, that allow sufficient magnification. This can be done by connecting the camera with a commercially available microscope. If such a microscope is used, image data can alternatively also be transferred directly to the computing device. However, in the context of this invention the use of a microscope is not, as a rule, absolutely necessary. The camera, for example a smartphone camera, can be combined with magnification optics.

According to the invention it is preferred for the magnification power of the inventive optical magnification device in the presence of the image processing device to be at least 10× or 100× or at least 1,000×, preferably 10× to 500×, 100× to 2,000×, especially 500× to 1,000×, possibly with a resolution of less than 0.5 μm, so that sufficient magnification of cells and pathogens can be achieved. This magnification factor can be fixed or variable.

The optical magnification device or image processing device preferably has one or more light sources of any kind, such as, e.g., at least one white light or fluorescent light, which is possibly used as an excitation light for fluorescent dyes (see below).

The term “means to mount a test strip having a body fluid” means that a chamber having a slot or insert or a holder can be used to arrange and fix a test strip to the optical magnification device, in particular in such a way that the image processing device along with at least one optical magnification device allows an optical read-out of the body fluid.

Therefore, the invention also relates to a test strip that is suitable for being mounted in the test system, the test strip being mounted in a chamber and only having an opening next to a slot or insert or a holder for the optical path of the optical magnification device.

In a variant, the chamber can be opened and closed, so that the test strip is mounted by laying it down or putting in a bracket (referred to below as the static method).

However, a slot or insert in the chamber is preferred, so that the test strip can be mounted by pushing it in and removed by pulling it out (referred to below as the dynamic method). Therefore, the test strip can be moved or transported relative to the inventive optics (see above).

According to the invention, such a test strip is preferably a planar test strip, preferably consisting of one or more transparent, hard material(s), such as a plastic or glass, that is able to hold a body fluid. Furthermore, it is preferred for the test strip to consist of two layers glued to one another, such as, e.g., a thin coverslip and a plastic strip. A synonym for test strip can be, e.g., chip.

The test strip possesses a sample port, preferably in the form of a well or funnel in the surface, for the application of a defined volume (e.g., 25 μL, 50 μL, 100 μL) of a body fluid sample from a subject, especially a patient.

In the context of this invention, “body fluid” includes, but is not limited to, blood, whole blood, urine, saliva (sputum), synovial fluid, fluid, cerebrospinal fluid, plasma or serum or tear fluid, sweat, lymph, or intercellular fluid.

A sample of a body fluid of a patient/subject can be treated with any chemicals or reagents, in particular stains and dyes, especially fluorescent dyes, possibly along with usual excipients and additives.

Such body fluids contain analytes, especially cells, that might possibly contain infected cells (see above) or pathogens as such.

In the context of this invention, “pathogens” can be, e.g., but are not limited to, bacteria, fungi, viruses, and eukaryotic unicellular organisms, such as, e.g., amoebae or eukaryotic parasites. The term “pathogen” should also be understood to include, but is not limited to, the causative agents of diseases such as: adenoviruses, Bacillus anthracis, Bordetella pertussis, Bordetella parapertussis, Borrelia recurrentis, Brucella spp., Campylobacter spp., Chlamydia psittaci, Clostridium botulinum, Corynebacterium diphtheriae, Coxiella burnetii, human pathogenic Cryptosporidium spp., Ebolavirus, Escherichia coli, enterohemorrhagic strains (EHEC), Francisella tularensis, tick-borne encephalitis virus, yellow fever virus, Giardia lamblia, Haemophilus influenzae, hantaviruses, hepatitis A virus, hepatitis B virus, hepatitis C virus, hepatitis D virus, hepatitis E virus, influenza viruses, Lassa virus, Legionella spp., human pathogenic Leptospira spp., Listeria monocytogenes, Marburg virus, measles virus, mumps virus, Mycobacterium leprae, Mycobacterium tuberculosis/africanum, Mycobacterium bovis, Neisseria meningitidis, Norwalk-like virus, poliovirus, Pseudomonas aeruginosa, rabies virus, Rickettsia prowazekii, rotavirus, rubella virus, Salmonella Paratyphi, Salmonella Typhi, Shigella spp., Trichinella spiralis, varicella zoster virus, Vibrio cholerae O1 and O139, Yersinia enterocolitica, Yersinia pestis, Treponema pallidum, HIV, Echinococcus spp., Plasmodium spp., Toxoplasma gondii. The invention also covers multi-resistant pathogenic bacteria (MRSA), such as Streptococcus pneumoniae, Streptococcus aureus, etc.

The term “analytes” includes, but is not limited to, substances and chemicals such as dissolved macromolecules (viruses, nucleic acids, protein complexes, proteins, peptides) or also small molecules (organic molecules, hormones, vitamins, metabolites, drugs), etc.

The term “patient” comprises every subject, irrespective of the symptoms or disease, and includes humans and animals, especially mammals.

The sample port can be provided with (dried) chemicals, agents, or additives (e.g., EDTA, heparin to inhibit coagulation), especially stains for histological cell staining or, especially preferred, means for lysis of infected cells (e.g., infected erythrocytes after infection with Plasmodium), possibly releasing the pathogens (e.g., by means of ammonium chloride, saponins, sucrose, etc.), which preferably are dissolved by the supplied sample of a body fluid (referred to below as sample).

In a preferred embodiment, the sample flows through the test strip, especially preferably by means of at least one incorporated or applied (micro)channel having a rectangular, trapezoidal, or arched cross section. The channel can be a capillary or allow flow by the effect of gravity. It is preferable for the (micro)channel to consist of an optically transparent material such as glass or a plastic, preferably a fluoropolymer with a refractive index similar [to or the] same as water, to allow optical detection.

Therefore, the invention also relates to a test strip that contains a sample port and at least one (micro)channel, especially at least one capillary.

In a preferred embodiment, the sample port contains a first funnel-shaped depression (10) into which one or more drops of capillary blood are put. In a lower area, this first funnel is subdivided into several, preferably three, subordinate compartments (20, 30, 40), for example by means of suitable dividers (50). The arranged dividers (50) each define the size of the compartments (20, 30, 40), and consequently the fraction of volume allotted to the compartments.

Therefore, the invention relates to a test strip that contains a sample port and a first funnel-shaped depression (10) that is subdivided into several compartments (20, 30, 40). Each compartment (20, 30, 40) has an opening, preferably together with a cell filter (“blood filter”), which opens into a common connection channel (90), however the compartments (20, 30, 40) have different path lengths to the detection chamber (110) and are arranged one behind the other (see FIG. 4). At least one compartment (20) contains a staining solution, preferably dried, possibly along with binders and other additives, in particular means for lysis of infected cells (e.g., infected erythrocytes after infection with Plasmodium). The largest compartment (30) is preferably arranged between the compartments (20), (40) and allows defined quantities of body fluids to be fed into the compartments (20), (40) (see FIG. 4).

The aforementioned cell filters (“blood filters”) allow larger blood cells to be held back, however let the pathogens through.

Capillary action (capillary suction) carries the pathogen-containing fluid from (40) through the connection channel (90) into the (micro)channel or detection space (110).

Consequently, at the confluence (60) of the feed pipe from (40) and the connection channel (90) an air bubble forms, which first separates the liquids from (40) and (20) and second stops the flow from (20) until reservoir (40) has been emptied. After that, the liquid level in (20) can exert pressure on the air bubble in the channel coming from (40), so that the staining solution flows into connection channel (90) to the following (micro)channel or detection space (110) with a delay.

Therefore, the invention relates to a test strip that contains a sample port and a first funnel-shaped depression (10) that is subdivided into several compartments (20, 30, 40) and that guides a sample, after separation, through a common connection channel (90) into a (micro)channel, without mixing and in sequence.

This advantageously allows defined aliquoting of the sample and also the use of staining solutions and additives. The reproducibility of the test results that this ensures is especially advantageous.

Therefore, the invention relates to a test strip that contains a sample port and a first funnel-shaped depression (10) that is subdivided into several compartments (20, 30, 40), the compartments (20, 30, 40) having openings, and a sample [with] pathogens from one compartment entering the (micro)channel or detection space (110) through a common connection channel (90) in a first step, and in a second step the (bound) pathogens being stained by a stain from a second compartment.

FIGS. 3 through 5 show a preferred embodiment of a microstructured sample port (sample inlet) for one or more drops of body fluid, such as, e.g., capillary blood, as discussed above.

The test strip can have one or more fields in which specific binders (130), such as, e.g., antibodies, ligands, proteins or aptamers, are bound to a first surface of the test strip, preferably in the form of a monolayer.

These fields along with the binders advantageously allow multiplex analyses, that is of various cells, infected cells, and pathogens next to one another.

Such binders are available to the person skilled in the art and are, for example, commercially available.

For example, in the case of Streptococcus pneumoniae, isolated C-polysaccharide or the surface protein PspA of the pathogens can serve as a target for a specific binder. The gene for the surface protein PspA is publicly accessible under NCBI gene ID 932894. From this gene sequence, standard processes can be used to produce a protein that serves as a target for isolating a binder of the above-indicated species. RNA binders can be isolated using the SELEX method (systematic evolution of ligands by exponential enrichment). SELEX is a process for isolating ligands with high affinity for a target protein from a pool of varying DNA or RNA sequences (molecule library). The oligonucleotide sequences obtained by means of SELEX are called aptamers (overview: Ellington A D, Szostak J W, Selection in vitro of single-stranded DNA molecules that fold into specific ligand-binding structures, Nature, 355 (1992), 850-852).

For this purpose, DNA molecules with variable sequences, i.e., a large population of different DNA variants, are produced on a DNA synthesizer. These randomized DNA sequences are flanked by defined DNA segments that are recognized by specific PCR primers. One of these defined segments contains the signal sequence to initiate transcription by T7 RNA polymerase. Typically, about 1,015 to 1,045 different DNA sequences are produced for one SELEX run.

The incubation of the nucleotide sequences with the targets can take place in the immobilized state or in solution. Wash steps separate sequences that are only weakly bound to the targets or not bound at all from the sequences that are bound.

Then, the better binders are amplified using reverse transcription (only for RNA) and the polymerase chain reaction (PCR). The result is a pool of DNA or RNA molecules with better ligand binding properties than the original molecule pool. This is the last step in the process, and it is now usually repeated eight to twelve times, until a desired aptamer is obtained.

The sequence of the aptamer found in this way can be determined using standard methods, and allows the aptamer to be produced in large quantities.

Various manufacturers offer commercial antibodies directed against PspA, for example goat anti-S. pneumoniae antibodies bN-18 or bF-19 of the company Santa Cruz Biotechnology, Inc.

Therefore, the specific binder can be, e.g., a nucleic acid aptamer, a PNA sequence, a monoclonal antibody, an antibody fragment, or an affibody (Gebauer M, Skerra A: Engineered protein scaffolds as next-generation antibody therapeutics. Curr Opin Chem Biol. June 2009).

Of course, according to the invention it is possible to proceed in a corresponding way for other pathogens, as is explained in the following examples:

E.g., in the case of Staphylococcus aureus (a bacterium), isolated surface antigen B, enterotoxin B, or manganese transporter protein MntC of the pathogen can serve as a target for a specific binder. Commercial antibodies are also available, for example the mouse monoclonal anti-S. aureus antibody clones 5622 and 5643 of the company Santa Cruz Biotechnology, Inc.

E.g., in the case of Pseudomonas aeruginosa (a bacterium), isolated mucoid exopolysaccharide of the pathogen can serve as a target for a specific binder. Commercial antibodies directed against serotypes 9 or 10 of P. aeruginosa are also available, for example mouse anti-P. aeruginosa antibody clone 276/11 or 95/159 of the company Santa Cruz Biotechnology, Inc.

E.g., in the case of Haemophilus influenzae (a bacterium), pneumococcal histidine triad D (PhtD), pneumolysin toxoid (dPly), or NTHi protein D (PD) of the pathogen can serve as a target for a specific binder. Commercial antibodies are also available, e.g., mouse monoclonal anti-H. influenzae antibodies of the company antibodies-online Inc.

E.g., in the case of Mycobacterium tuberculosis (a bacterium), the surface antigen PE_PGRS16 of the pathogen can serve as a target for a specific binder. Commercial antibodies directed against M. tuberculosis are also available, e.g., polyclonal rabbit anti-M. tuberculosis antibodies of the company abcam plc.

E.g., in the case of Neisseria gonorrhoeae (a bacterium), surface antigen Omp85 can serve as a target for a specific binder (GenBank®: AAC17600.1). Commercial antibodies directed against N. gonorrhoeae are also available, e.g., polyclonal rabbit anti-N. gonorrhoeae antibodies of the company antibodies-online Inc.

E.g., in the case of Corynebacterium diphtheriae (a bacterium), the surface antigen proteins DIP1281 or SpA of the pathogen can serve as a target for a specific binder. Commercial antibodies directed against C. diphtheriae are also available, e.g., mouse monoclonal anti-C. diphtheriae antibodies of the company antibodies-online Inc.

E.g., in the case of Bordetella pertussis (a bacterium), LOS-A or the specific adhesins that selected aptamers of the pathogen need for adhesion to the ciliated epithelium can serve as a target for a specific binder. Commercial antibodies directed against B. pertussis are also available, e.g., mouse monoclonal anti-B. pertussis antibodies of the company antibodies-online GmbH.

E.g., in the case of Salmonella enterica (serovar Typhi) (a bacterium) the nonfimbrial protein SiiE of the pathogen can serve as a target for a specific binder. Commercial antibodies directed against S. enterica are also available, e.g., mouse monoclonal anti-S. enterica antibodies of the company antibodies-online Inc.

E.g., in the case of Yersinia pestis (a bacterium), the adhesin Ail, plasminogen activator (Pla), or pH 6 antigen (Psa) of the pathogen can serve as a target for a specific binder. Commercial antibodies directed against Y. pestis are also available, e.g., mouse monoclonal anti-Y. pestis antibodies of the company abcam plc.

E.g., in the case of Campylobacter jejuni (a bacterium), the FlhF protein of the pathogen can serve as a target for a specific binder. Commercial antibodies directed against C. jejuni are also available, e.g., mouse monoclonal anti-C. jejuni antibodies of the company abcam plc.

E.g., in the case of Legionella pneumophila (a bacterium), the PAL protein or other components of the bacterial lipopolysaccharide layer of the pathogen can serve as a target for a specific binder. Commercial antibodies directed against L. pneumophila are also available, e.g., mouse monoclonal anti-L. pneumophila antibodies of the company antibodies-online Inc.

E.g., in the case of Listeria monocytogenes (a bacterium), the autolysin of the pathogen can serve as a target for a specific binder. Commercial antibodies directed against L. monocytogenes are also available, e.g., rabbit polyclonal anti-L. monocytogenes antibodies of the company antibodies-online Inc.

E.g., in the case of hepatitis B virus, the pathogen's PreS1 (a specific envelope protein) can serve as a target for a specific binder. Commercial antibodies directed against HBV are also available, e.g., mouse monoclonal anti-HBV antibodies of the company antibodies-online Inc.

E.g., in the case of hepatitis C virus, the E1-E2 dimer of the pathogen's viral envelope can serve as a target for a specific binder. Commercial antibodies directed against HCV are also available, e.g., mouse monoclonal anti-HCV antibodies of the company antibodies-online Inc.

E.g., in the case of Japanese encephalitis virus, domain II of the viral pathogen's envelope protein (E) can serve as a target for a specific binder. Commercial antibodies directed against Japanese encephalitis virus are also available, e.g., mouse monoclonal anti-Japanese encephalitis virus antibodies of the company antibodies-online Inc.

E.g., in the case of Candida albicans (a fungus), polysaccharides of the of the pathogen's cell wall can serve as a target for a specific binder. Commercial antibodies directed against C. albicans, are also available, e.g., mouse monoclonal anti-C. albicans antibodies of the company antibodies-online Inc.

E.g., in the case of Aspergillus fumigatus (a fungus) the pathogen's protein Cfr1 can serve as a target for a specific binder. Commercial antibodies directed against A. fumigatus, are also available, e.g., mouse monoclonal anti-A. fumigatus antibodies of the company antibodies-online Inc.

E.g., in the case of Plasmodium falciparum (a bacterium) the proteins MSP-1 (merozoite surface protein), AMA1 (apical membrane antigen 1), or EMP1 (also called PfEMP1/knob) of the pathogen can serve as a target for a specific binder. Commercial antibodies directed against P. falciparum are also available, e.g., mouse monoclonal anti-P. falciparum antibodies of the company Santa Cruz Biotechnology, Inc.

E.g., in the case of Plasmodium vivax (a bacterium), the pathogen's circumsporozoite protein (CSP) can serve as a target for a specific binder. Commercial antibodies directed against P. vivax are also available, e.g., mouse monoclonal anti-P. vivax antibodies of the company Santa Cruz Biotechnology, Inc.

Therefore, the person skilled in the art is able to supply suitable binders, preferably polyclonal or monoclonal antibodies or aptamers for the respective cells, infected cells, or pathogens.

Therefore, the invention relates to a test system comprising the following:

i.) a mobile computing device;
ii.) an image processing device arranged on at least one optical magnification device; and
iii.) Means to mount a test strip having a body fluid;
iv.) Test strips containing one or more binders and/or at least one (micro)channel.

Such binders can be, for example, printed, fixed, or immobilized, and serve as collectors of the cells, infected cells, or pathogens, which consequently concentrate out of the sample (fluid) on the surface of the test strip.

As was already explained, the test strip preferably has several fields with the same or different binders (collectors). Different fields can have different binders (collectors) assigned to them, each of which concentrates specific cells, infected cells, or pathogens.

The aforementioned (micro)channel preferably runs through the fields, the body fluid sample being able to come into contact with the binders on the fields.

To prevent laminar flow of the cells on the test strip or through the aforementioned channel and increase the probability of contact with the binders or binder-coated fields, turbulent mixing can be caused by placing, in the channel or on the test strip, interfering structures in the form of round, oval, triangular, square, rectangular, or polygonal bumps, which preferably stand transverse to the direction of flow.

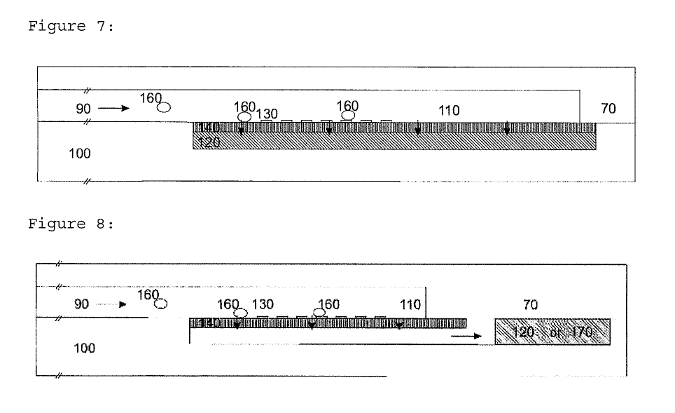

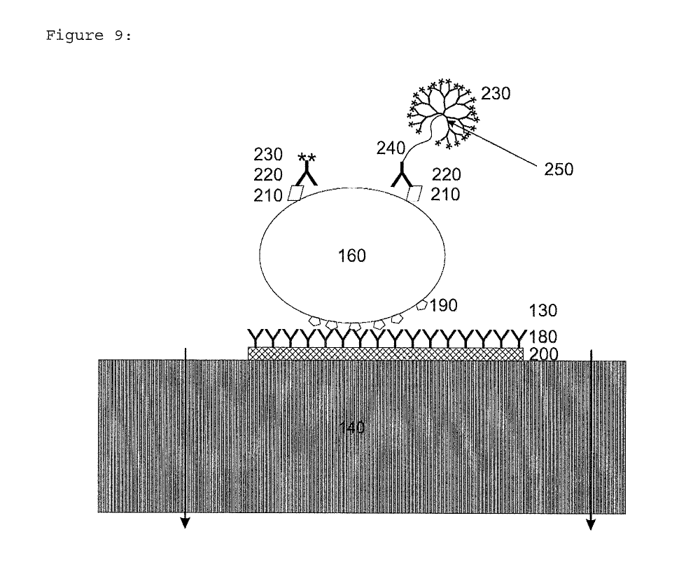

Furthermore, the test strip can contain a (nano)porous membrane (140) (pore size 50 to 400 nm), which produces an additional outflow and consequently draws the cells, infected cells, or pathogens (160) onto the test strip or fields to the binders (collectors) (130). To establish a sufficient capillary flow, the test strip can have a capillary pump (170). Alternatively, it is also possible to use a filter paper, mat, or something similar (120) below it or next to it. Preferred embodiments are explained in FIGS. 7 and 8.

Therefore, the invention relates to a test strip described above containing a (nano)porous membrane (140) (pore size 50 to 400 nm), and optionally a capillary pump (170) or filter paper or mat (120).

In another embodiment, the (micro)channel can be equipped with an electric field, the field preferably being oriented at a right angle to the surface of the test strip. Consequently, charged pathogens can, for the most part, be directed in the direction of the binders (130). The electric field can be created by means of conventional electrodes and sufficient field strength along the test strip and/or the (micro)channel.

The binders recognize the sought-after cells, infected cells, or pathogens on the basis of specific targets, such as surface markers, or something similar, capture them from the sample flow and bind, fix, or immobilize them on a first surface of the test strip or a designated field.

In a special embodiment of the inventive test strip, bars, markings (300) (see FIG. 6a), or a dot code (310) can be printed between the fields, preferably orthogonal to the direction of flow (see FIG. 6b). These advantageously visually delimit the fields for image processing and for determination, by evaluation software, of the pull-through speed the user is using on the test strip (see also “dynamic method”).

Optionally, in front of or behind (downstream or upstream of) the fields it is possible to print a barcode (320) containing the usual information on the test strip, e.g., the type of test (malaria pathogen, HIV, or batch number) and/or the expiration date of the test strip, etc.

In another embodiment, it is also possible to use a mimetic that is on the order of magnitude of a cell or a pathogen and that has the same or different binders and is also specifically bound by the binders on at least one field.

Examples of such mimetics are (latex or polystyrene) beads, magnetic spherules or spheroids containing the same or different binders, which have been added to the sample or at least put on a field of the test strip.

This mimetic allows quantitative detection of any analytes from the body fluid, such as dissolved macromolecules (viruses, nucleic acids, protein complexes, proteins, peptides), or also small molecules (organic molecules, hormones, vitamins, metabolites, drugs). To do this, it is necessary to put in an “artificial cell” (mimetic) to which these soluble molecules or viruses specifically bind or are addressed, to produce a situation that corresponds to the presence of pathogen-specific markers on real cells.

Therefore, the invention also relates to an inventive test system containing a test strip that has one or more fields that have at least one binder that is the same or different, that are suitable to bind one or more analytes, cells, infected cells, or pathogens, possibly by means of a mimetic, especially in the form of beads, magnetic spherules and/or spheroids.

According to the invention, the field can be of any size and be designated for any purpose. However, it is preferable to designate several fields that are spatially separated from one another.

This concentrates the infected cells or pathogens on at least one of these fields, while gravity or capillary action carries the liquid sample farther, preferably into a collection reservoir (e.g., a sponge, reservoir, mat, fabric, etc.). Alternatively, it is also possible for a micropump to be provided at the end (e.g., Micropump mp6, Bartels Mikrotechnik GmbH). The cells or pathogens can maintain their physiological form in the liquid.

The infected cells or pathogens can also be concentrated mechanically by a sieve or filter or by narrowing the aforementioned (micro)channel.

The cells can also be concentrated biologically, for example as specific aggregates. Such aggregates can be obtained, e.g., by adding fibrinogen to form rouleaux of erythrocytes.

Therefore, in another embodiment the invention relates to a test system containing a test strip, at least one or more analytes, cells, or pathogens being localized, in particular mechanically localized.

In a second step, the infected cells or pathogens can be stained by adding a staining solution to the sample port, which has been emptied in the meantime, or from a blister depot that is opened by mechanical action and empties into the channel. Depending on the analyte or test design, the stain is preferably a simple histological stain of the cytoplasm and the DNA in the cell nuclei or an immunochemical stain (e.g., Giemsa).

Here it is preferable to use other antibodies, peptides or aptamers (referred to below as stain ligands), which bind to a second independent binding site on the surface of the immobilized or captured cells. These ligands are preferably conjugated with a fluorescent dye, so that their binding to the cell surface produces a sufficient fluorescence signal that the optical magnification makes visible against the background, so that individual imageable color values or color contrasts are produced, as discussed above.

Therefore, the invention also relates to a test system, in which the analytes, cells, or pathogens bound to the test strip are color stained by means of a stain ligand that is conjugated with a dye, preferably a fluorescent dye, consequently allowing inventive image evaluation.

This double identification in the “sandwich system”, on the one hand by the binder (capture ligand) and, on the other hand, by the (subsequent) stain ligand, allows unambiguous typing of the infected cells or pathogens and excludes false positives due to nonspecific binding of other cells.

Corresponding binders (capture ligands) and stain ligands for cells and pathogens are described in the literature and can be correspondingly used by the person skilled in the art. For example, infected cells (malaria, cholera, etc.) have corresponding surface markers that can be recognized by the binders (capture ligands and stain ligands).

The process allows the concentration and unambiguous visual identification of cell types such as, e.g., malaria-infected erythrocytes, CD4+ cells, or also infected cells in HIV diagnosis, also the identification and typing of bacteria in the diagnosis of, e.g., sepsis, cholera, tuberculosis, etc.

The concentration and identification is even possible in multiplex for many cell types or pathogens. To do this, the different fields in the (micro)channel are each coated with different binders, each of which specifically captures and concentrates a desired cell type or pathogen. The immunochemical labeling is done by means of flow through a mixture of ligands, preferably fluorescence labeled ligands, for all desired cell types or pathogens, which are specifically stained by these ligands.

The background signal of the specific labeling, which is due e.g., to the staining solution remaining in the channel, is irrelevant during measurement, since the staining solution should preferably have a low concentration. For example: Given a volume of 0.1 μL in the microchannel (capillary) (0.1 mm×0.02 mm×50 mm) and 0.0002 μL over a field (0.1 mm×0.1 mm×0.2 mm), if 50 μL low-concentration staining solution is input, it will be exchanged 500× in the capillary and 250,000× over a field.

Therefore, after the sample is added, the test strip allows the specific concentration and immobilization of certain cells or pathogens from the body fluid sample in the first flow-through step. Addition of a staining solution, usually afterwards, both washes all remaining unbound cells out of the microchannel, and also labels the cells or pathogens with a (fluorescent) dye, preferably specifically. It is especially advantageous that the invention need not require any additional wash step.

To further intensify the color signal, it is possible to use polymers, preferably dendrimers, which carry an intensely luminous fluorophore on each of their up to 1,000 ends (also called “amplification complex”).

Such dendrimers have other ligands such as antibodies, peptides, and aptamers in addition to the fluorophores. Thus, the resulting molecules are similar to the above-mentioned stain ligands, however have many more fluorophores per molecule. It is also possible to use different dendrimers which have different fluorophores that are specifically excited at the same or different specific wavelengths, and fluoresce with maxima of different wavelengths.

As soon as the staining fluid is completely distributed in the channel or has flowed through it, unbound stain ligands, possibly amplified with dendrimers, are uniformly distributed in the channel.

Cells that are immobilized on the fields in the channel carry label-bound stain ligands on their surfaces. The concentration of stain ligands in the staining fluid is preferably selected in such a way that stain ligands are concentrated on the infected cells or pathogens in comparison with the free stain ligands present in the fluid.

This makes infected cells appear as more brightly stained/fluorescent points or surfaces against a stained/fluorescent background, so they contrast against it, while uninfected cells remain invisible.

Surprisingly, according to the invention 2-5 detected pathogens are already sufficient, and assuming a capture efficiency of 10%, 10 μL of input whole blood consequently contain 20-50 pathogens. Therefore, the detection limit is especially advantageous: 3-5 pathogens per μL of blood. Test strips that are already commercially available (lateral flow tests), which [detect] malaria through the indirect detection of soluble pathogen proteins in blood (HRP II, aldolase, S antigen), have a sensitivity of about 100 pathogens per μL.

For comparison: In the symptomatic, rather unremarkable initial stage of malaria, parasitemia is 2-5 pathogens per μL, whereas during an attack of fever parasitemia of 100,000 pathogens per μL can occur.

In the presence of (excitation) illumination, the color contrasts of brightly stained/fluorescent cells against a stained/fluorescent background can undergo the inventive image evaluation. The number of infected cells per volume of sample can be determined by counting the bright points or surfaces and performing a calculation (integration, see above), since the sample volume and the binding efficiency of the fields are known. Calibration might be necessary.

When the sample-loaded test strip is mounted in the test system, the above measures can obtain a sufficient color intensity and color contrast effect along with sufficient color values for one or more image(s), which can be read out through the inventive optical magnification device and image processing device in the mobile computing device, as discussed above, so that effective image processing can be done.

In the case of the above-mentioned “static method”, it is possible to obtain pictures or series of pictures (also video) with sufficient diagnostic informative value, allowing qualitative analysis or diagnosis. For example, it is possible to state that a malaria pathogen is present in the body fluid.

However, it is especially preferred to use the above-mentioned “dynamic method”, in which several fields of the test strip can be optically read in one series of pictures or video sequence. The test strip should preferably be transported/moved at a uniform [speed] relative to the optical magnification device. For simplicity, this can be done by carefully pulling the test strip out manually or especially by means of an electric motor-driven transport system, a spring wind-up motor, or a gas spring, which is compressed by insertion [of the test strip].

Therefore, the invention also relates to a process, the test system comprising the following:

i.) a mobile computing device;
ii.) an image processing device arranged on at least one optical magnification device; and
iii.) means to mount and remove a test strip having a body fluid of a (patient/subject) sample or an embodiment described above, which essentially comprises the following steps:
a.) Applying a body fluid to a test strip, at least one binder localized on the test strip binding an analyte, cell, or pathogen;
b.) Applying a dye to a test strip, color staining one or more analytes, cells, or pathogens from a.);
c.) Making at least one contrast picture from b.) available for image processing and evaluating it in the mobile computing device.

The process is suitable, e.g., for sufficient identification of analytes, cells, or pathogens.

It is further preferred for the test strip to be transported or moved relative to the inventive optics, in particular for optical magnification, (so-called “dynamic method”).

Therefore, the invention relates to an additional optional process step b′) in which the test strip is transported or moved relative to the inventive optics, in particular for optical magnification.

The optical magnification device along with means to mount a test strip having a body fluid can be the object of an attachment for the mobile computing device, such as, e.g., a smartphone, or [it can be] in the form of a docking station (by means of a connector/interface plug or wireless), or a Bluetooth® or WLAN device.

In the case of a smartphone or tablet computer, the attachment will, as a rule, cover at least parts of the back surface. It can be mechanically, magnetically, and detachably connected with the smartphone or tablet computer. An attachment can also be offered in the form of a table stand (for example, a docking station). The table stand can have its own (rechargeable) power supply and also assume additional functions, for example, serve as a charging station for the smartphone or tablet computer. A table stand or other attachment can be sold independently of a smartphone or tablet computer, and together with a common smartphone or tablet computer it becomes a powerful analysis station.

The test system can be correspondingly built by the above-mentioned features, even if these features relate to the inventive process.

Therefore, the invention relates to an attachment or table stand, especially in the form of a docking station containing optical magnification along with means to mount a test strip as described above, which is/can be connected with a mobile computing device containing an image processing device.

Furthermore, the invention relates to the use of an inventive test system or test process for diagnosis of diseases of all kinds, especially infectious diseases, this diagnosis involving the evaluation and inventive identification of cells, infected cells, pathogens, or meaningful analytes, allowing conclusions to be drawn about a disease of a patient/subject. This relates especially to diseases caused by fungi, viruses and bacteria, or pathogens or causative agents, in particular ones such as adenoviruses, Bacillus anthracis, Bordetella pertussis, Bordetella parapertussis, Borrelia recurrentis, Brucella spp., Campylobacter spp., Chlamydia psittaci, Clostridium botulinum, Corynebacterium diphtheriae, Coxiella burnetii, human pathogenic Cryptosporidium spp., Ebolavirus, Escherichia coli, enterohemorrhagic strains (EHEC), Francisella tularensis, tick-borne encephalitis virus, yellow fever virus, Giardia lamblia, Haemophilus influenzae, hantaviruses, hepatitis A virus, hepatitis B virus, hepatitis C virus, hepatitis D virus, hepatitis E virus, influenza viruses, Lassa virus, Legionella spp., human pathogenic Leptospira spp., Listeria monocytogenes, Marburg virus, measles virus, mumps virus, Mycobacterium leprae, Mycobacterium tuberculosis/africanum, Mycobacterium bovis, Neisseria meningitidis, Norwalk-like virus, poliovirus, Pseudomonas aeruginosa, rabies virus, Rickettsia prowazekii, rotavirus, rubella virus, Salmonella Paratyphi, Salmonella Typhi, Shigella spp., Trichinella spiralis, varicella zoster virus, Vibrio cholerae O1 and O139, Yersinia enterocolitica, Yersinia pestis, Treponema pallidum, HIV, Echinococcus spp., Plasmodium spp., Toxoplasma gondii. The invention also covers multi-resistant pathogenic bacteria (MRSA), such as Streptococcus pneumoniae and Streptococcus aureus.

### EXAMPLES AND FIGURES

These examples serve exclusively to explain the invention, without limiting it to these examples.

### DESCRIPTION OF THE FIGURES

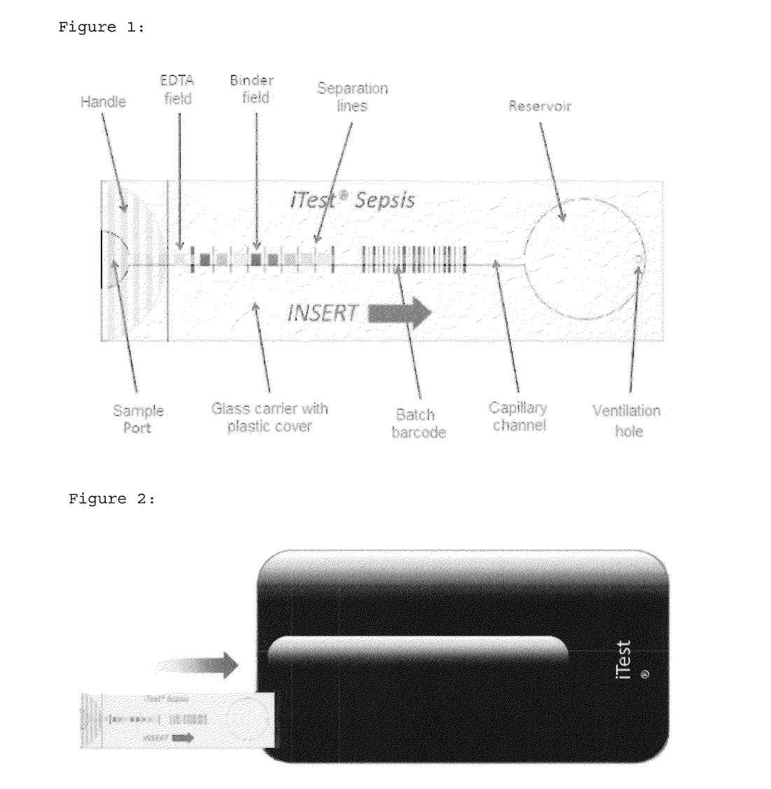

FIG. 1 describes a preferred embodiment of an inventive test strip.

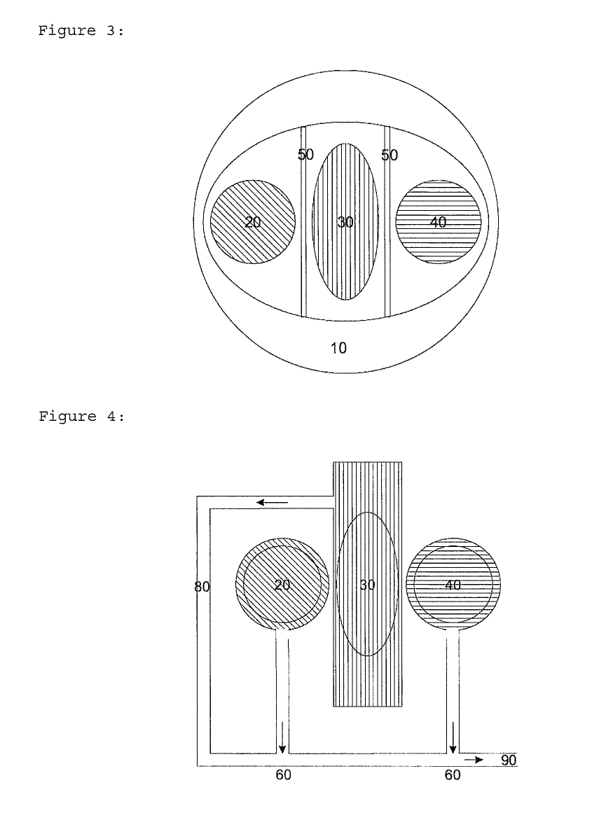

FIG. 2 shows the mounting of a test strip into the inventive device using a smartphone (below), an optical magnification along with suitable chamber being arranged above the digital camera.

FIG. 3: Top view of the funnel-shaped sample port (10), however with the sample port (10) subdivided into three subfunnels (compartments: 20, 30, 40) by means of dividers (50).

FIG. 4: Top view of the arrangement with the (compartments: 20, 30, 40) and connection channel (90) along with microchannels supplying them.

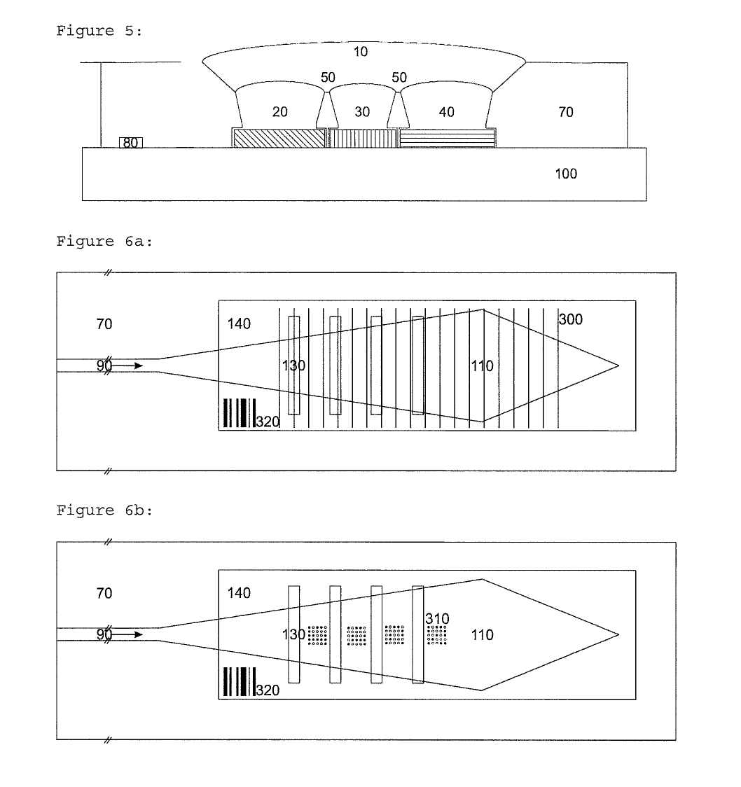

FIG. 5: Cross section of the arrangement in FIGS. 3 and 4 along with holder (70) and support (100).

FIG. 6a: Top view of a test strip (70) having a nanoporous membrane (140) coated with fields along with binders (collectors) (130), a sample containing pathogens (160) being able to enter the detection space (110) through the connection channel (90), and [the test strip] having labels (300). A barcode (320) is also provided.

FIG. 6b: Top view of a test strip (70) having a nanoporous membrane (140) coated with fields along with binders (collectors) (130), a sample containing pathogens (160) being able to enter the detection space (110) through the connection channel (90) and [the test strip] having a DotCode (310). A barcode (320) is also provided.

FIG. 7: Top view of a test strip (70) along with a support (100) having a nanoporous membrane (140) and additionally having filter paper (120) below it, coated with fields along with binders (collectors) (130), a sample containing pathogens (160) being able to enter the detection space (110) through the connection channel (90). The arrows clearly show the suction direction for the pathogens (160) produced by the outflow that is achieved.

FIG. 8: Cross section of a test strip (70) along with a support (100) having a nanoporous membrane (140) and filter paper (120) or a capillary pump (170) arranged next to it, coated with fields along with binders (collectors) (130), a sample containing pathogens (160) being able to enter the detection space (110) through the connection channel (90). The arrows clearly show the suction direction [for] the pathogens (160) produced by the outflow that is achieved.

FIG. 9: A nanoporous membrane (140) is coated with fields with binders (130) consisting of a layer (200) and collectors, here: antibodies (180). The layer (200), made, e.g., of polyethylene glycol (PEG), prevents nonspecific binding of cells/pathogens to the surface. PEG forms a gel-like layer, so that the antibody contact (180) with cells/pathogens is increased by sinking and greater spatial flexibility of the antibodies (180).

The pathogens (160) glide over the surface and bind to the collectors (180) with their surface antigens (190). Only the bottom of the pathogen (160) is blocked. Other deviating antigens (210) on the top of the pathogens are freely accessible and bind to added detection antibodies (220). Conventionally, these are fluorescence-labeled by direct conjugation of a few fluorophores.

Preferably, a signal amplifier complex should be used, which binds up to a hundred fluorophores on an antibody and produces a stronger fluorescence signal. The detection antibody (220) is conjugated to a dendrimer (250) through a linker (240), e.g., an individual PEG molecule. The surface of this contains hundreds of chemical groups, e.g., amino groups, to each of which a fluorophore has been conjugated.

1-24. (canceled)

25. A test system comprising the following:
i.) a mobile computing device;
ii.) an image processing device arranged on at least one optical magnification device; and
iii.) Means to mount a test strip having a body fluid.

26. The test system described in claim 25, characterized in that the test strip is arranged in such a way that the image processing device along with at least one optical magnification device allows optical read-out of the body fluid.

27. The test system described in claim 25, characterized in that the mobile computing device is a smartphone or tablet computer, and the image processing device is a digital camera, which preferably is integrated in the smartphone or tablet computer or is located in a separate device connected with the smartphone or tablet computer.

28. The test system described in claim 25, the optical magnification device containing at least one objective or an arrangement of one or more objectives or lenses, in particular in the form of a microscope.

29. The test system described in claim 25, the optical magnification device in the presence of the image processing device achieving magnifications of at least 10× or at least 100× or at least 1,000×.

30. The test system described in claim 25, the optical magnification device or image processing device having one or more light sources of any kind, especially at least one white light or fluorescent light.

31. The test system described in claim 25, the means to mount a test strip having a body fluid being a chamber having a slot or insert or a holder for a test strip.

32. The test system described in claim 25, containing a test strip, the test strip being inserted or withdrawn through a slot or insert by means of an electric motor-driven transport system, a spring wind-up motor, or a gas spring.

33. The test system described in claim 25, containing a test strip, allowing analytes, cells, and pathogens to be localized and concentrated on the test strip.

34. A test system comprising the following:
i.) a mobile computing device;
ii.) an image processing device arranged on at least one optical magnification device; and
iii.) Means to mount a test strip having a body fluid
iv.) Test strips containing one or more binders and/or at least one (micro)channel.

35. The test system described in claim 34, containing a test strip that has one or more fields that have at least the same or different binders, that are suitable to bind one or more analytes, cells, or pathogens, possibly by means of a mimetic, especially in the form of beads, magnetic spherules and spheroids.

36. The test system described in claim 34, containing a test strip, characterized in that the test strip contains a sample port and at least one (micro)channel, especially at least one capillary, possibly along with markings (300), a DotCode (310) and/or a barcode (320).

37. The test system described in claim 34, containing a test strip, characterized in that the test strip that contains a sample port and at least one (micro)channel, along with means for lysis of infected cells.

38. The test system described in claim 34, containing a test strip, characterized in that the test strip contains a porous membrane (140), and optionally a capillary pump (170) or filter paper or mat (120).

39. The test system described in claim 34, containing a test strip, the analytes, cells, or pathogens contained on the test strip being color labeled by means of a stain ligand such as an antibody, aptamer, or peptide ligand that is conjugated with a dye, preferably a fluorescent dye.

40. A test system containing a test strip described in claim 34, the stain ligand containing an amplifier complex made of a polymer that is labeled with many fluorophores.

41. A test process for performing [tests] on a test system described in claim 34, comprising the following steps:
a.) Applying a body fluid to a test strip, at least one binder localized on the test strip binding an analyte, cell, or pathogen;
b.) Applying a dye to a test strip, color staining one or more analytes, cells, or pathogens from a.);
c.) Optionally, transporting or moving the test strip relative [to the inventive optics] for optical magnification.
d.) Making at least one contrast picture from b.) available for image processing and evaluating it in the mobile computing device.

42. The use of a test system or test process described in claim 34 for diagnosis of diseases.

43. The use of a test system or test process described in claim 34 for diagnosis of diseases, especially infectious diseases, diseases caused by fungi, viruses and bacteria, or pathogens or causative agents, in particular adenoviruses, Bacillus anthracis, Bordetella pertussis, Bordetella parapertussis, Borrelia recurrentis, Brucella spp., Campylobacter spp., Chlamydia psittaci, Clostridium botulinum, Corynebacterium diphtheriae, Coxiella burnetii, human pathogenic Cryptosporidium spp., Ebolavirus, Escherichia coli, enterohemorrhagic strains (EHEC), Francisella tularensis, tick-borne encephalitis virus, yellow fever virus, Giardia lamblia, Haemophilus influenzae, hantaviruses, hepatitis A virus, hepatitis B virus, hepatitis C virus, hepatitis D virus, hepatitis E virus, influenza viruses, Lassa virus, Legionella spp., human pathogenic Leptospira spp., Listeria monocytogenes, Marburg virus, measles virus, mumps virus, Mycobacterium leprae, Mycobacterium tuberculosis/africanum, Mycobacterium Bovis, Neisseria meningitidis, Norwalk-like virus, poliovirus, Pseudomonas aeruginosa, rabies virus, Rickettsia prowazekii, rotavirus, rubella virus, Salmonella Paratyphi, Salmonella Typhi, Shigella spp., Trichinella spiralis, varicella zoster virus, Vibrio cholerae O1 and O139, Yersinia enterocolitica, Yersinia pestis, Treponema pallidum, HIV, Echinococcus spp., Plasmodium spp., Toxoplasma gondii. The invention also covers multi-resistant pathogenic bacteria (MRSA), such as Streptococcus pneumoniae and Streptococcus aureus.

44. A test strip containing a sample port, a first funnel-shaped depression (10) being subdivided into several compartments (20, 30, 40) and guiding a sample, after separation, through a common connection channel (90) into a (micro)channel, without mixing and in sequence.
